(19) United States
(12) Patent Application Publication
(10) Pub. No.: US 2025/0355267 A1
(43) Pub. Date: Nov. 20, 2025

(54) BEAM EXPANDER FOR A REPLICATION APPARATUS

(71) Applicant: Carl Zeiss Jena GmbH, Jena (DE)

(72) Inventor: Yi Zhong

(21) Appl. No.: 18/869,274

(22) PCT Filed: May 24, 2023
(86) PCT No.: PCT/EP2023/063906

§ 371 Date: Nov. 25, 2024

(30) Foreign Application Priority Data
May 27, 2022 (DE) 102022205310.9

(51) Int. Cl. G02B 27/09; G02B 27/30

(52) U.S. Cl. CPC G02B 27/0983; G02B 27/30

(57) ABSTRACT

A system (100, 300) for adapting a diameter of a photon beam (S′, S″) comprises: a first element (1) with a curved surface which bas a first and a second focus (F1, F2). The system may be set up such that the photon beam is focused into the first focus (F1), so that the photon beam is focused onto the second focus (F2) after reflection at the surface of the first element (1).

### 1. TECHNICAL FIELD

The present invention relates to a system for adapting a diameter of a photon beam, a projection device and a corresponding method and computer program.

### 2. PRIOR ART

For various optical applications it can be helpful to adapt an existing photon beam in its diameter. For example, it may be helpful to scale the photon beam to a specific diameter. The adaptation of the diameter of a photon beam may be used for example in an optical magnification system (for example a zoom system, a projection device, a replication device, a display device, etc.). Usually, optical magnification systems can be realized by a system of different optical lenses, with the photon beam passing through the lenses in order to be set to a defined diameter. To adapt the diameter, it is usually necessary to precisely adjust or fine-tune one or more optical elements of the lens system (for example by way of a defined offset of one or more lenses). Depending on the complexity of the optical lens system and the technical requirements for the adaptation of the diameter, this can pose a considerable technical challenge. This is made even more difficult since in the case of lenses optical imaging errors (i.e. aberrations) usually cannot be avoided, which means that they either have to be tolerated or reduced by a complex optical design.

In addition, optical magnification systems which rely on reflective optical elements are also known. The beam path of the photon beam may in this case have usually complex deflections with respect to an optical axis, since the adaptation of the diameter of the photon beam in such reflective magnification systems usually cannot take place in a defined manner along an optical axis as it can in the case of a lens system. Therefore, high technical requirements for adjusting the optical elements, as well as for ensuring the optical quality, often arise even for reflective magnification systems.

The object of the present invention is therefore to improve and/or simplify the adaptation of a diameter of a photon beam.

### 3. SUMMARY OF THE INVENTION

This object is at least partly achieved by the various aspects of the present invention.

A first aspect concerns a system for adapting a diameter of a photon beam. The system comprises a first element with a curved surface which has a first and a second focus. The system is set up such that the photon beam is focused into the first focus, so that the photon beam is focused onto the second focus after reflection at the surface of the first element.

The invention therefore allows defined conducting of the photon beam through the system for adapting its diameter, since the photon beam focused onto the first focus is always output in a defined manner at the second focus of the first element by way of its reflection at the first element. The first element can therefore be understood as a reflective deflecting unit of the photon beam in the system. The deflecting of the photon beam can accordingly work without an active adjustment of the first element, since it is possible to make use in the system of the fact that the photon beam focused at the first focus is always output as focused at the second focus. There is therefore no need for specific adjustment or focusing onto the position of the second focus. The invention can accordingly make it possible to reduce the complexity in a system for adapting a diameter of a photon beam. At the same time, the optical quality of the photon beam during the defined conducting or deflecting can be ensured, since the first element can be configured in such a way that no (significant) aberration is introduced to the photon beam during the reflection of the photon beam at the first element. For example, the invention can in this respect avoid an aberration which is typically associated with passing/transmitting a photon beam through two media (for example in the case of a lens). The optical quality of the photon beam focused at the first focus can therefore correspond (substantially) to the optical quality of the reflected photon beam at the second focus. In one example, the first element may thus allow the wavefront of the photon beam to be conducted without aberration from the first focus to the second focus, without a need for (for example complex) adjustment or correction, and at the same time the curved surface may be designed such that a numerical aperture of the photon beam is changed during the reflection, so that after collimation a changed output diameter of the photon beam can be achieved (without requiring a movable collimator).

Therefore, a system for adapting a diameter of a photon beam which does not require lenses, and therefore does not have significant chromatic aberration, can be provided. It can therefore be used over a great wavelength range without any aberrations occurring. The system may for example work exclusively with reflective elements.

In one example, the curved surface of the first element may be at least partially concave, while the system may be set up such that the photon beam is incident on a concave region. By focusing onto the first focus, the photon beam can accordingly be incident on a concave portion of the surface of the first element which reflects or focuses the photon beam into the second focus of the first element. The curvature of the surface may for example be locally different or vary locally.

The curved surface may for example extend in a first plane, while the first element has no curvature along a second plane orthogonal to it. The incident photon beam may for example lie in the first plane. In other examples, the curved surface is also curved in the second plane. The curvature in the second plane may for example correspond substantially to the curvature in the first plane.

In one example, the first element comprises an elliptical mirror. The elliptical mirror may in this case have two focal points, which correspond to the first focus and the second focus of the first element. The elliptical mirror may in this case have a concave region at least along one plane. For example, the elliptical mirror may be described by an elliptical curve exclusively along one plane. In another example, the elliptical mirror may have a concave region along each of two orthogonal planes. For example, the geometry of the surface of the mirror may be mathematically described by an ellipse (for example by an elliptical curve and/or an ellipsoidal surface).

In one example, the system comprises a first output coupler which collimates the photon beam to a first output diameter after reflection at the first output coupler. The photon beam collimated by the first output coupler may in this case correspond to the photon beam previously reflected at the first element. The first output coupler may for example have a curved surface, which receives the photon beam, so that the photon beam is reflected at the curved surface in such a way that after this reflection the photon beam is collimated to a (defined) first starting diameter. In one example, the curved surface of the first output coupler may comprise a concave region on which the incident photon beam is incident. The geometry of the curved surface may for example be locally different and/or mathematically described by a parabola (for example by a parabolic curve/surface). In one example, the first output coupler comprises a parabolic mirror. The parabolic mirror may in this case have the corresponding curvature at least along one axis. For example, the parabolic mirror may have a concave region exclusively along one plane. In another example, the parabolic mirror may have a concave region along each of two orthogonal planes.

In one example, the output coupler is arranged after the second focus of the first element, so that the photon beam incident on the output coupler was previously focused onto the second focus of the first element. In this case, the photon beam diverging from the second focus can therefore be incident on the output coupler and be collimated to the first output diameter.

In another example, the first output coupler comprises an output coupler which collimates the photon beam to a first output diameter without reflection. In this example, the first output coupler may comprise for example a collimating lens, a collimating lens system and/or a collimator, which does not necessarily have to comprise reflective elements.

In one example, the first element and the first output coupler are arranged in relation to one another such that a focus of the first output coupler and the second focus of the first element are substantially in the same position. This can allow a tuning of the first element with the first output coupler, since it is therefore given that the photon beam is not only focused into the second focus of the first element, but is in this case also at the same time focused into the focus of the first output coupler, and therefore always output as collimated without any other aids.

In one example, the first element and the first output coupler may be arranged positionally fixed in relation to one another. Thus, the first element and the first output coupler may be configured as relatively immovable in relation to one another, which means that there is no need for a local tuning of the two components (for example during the adaptation of the photon radiation), so that the system complexity is reduced.

It should be mentioned that in another example, the first output coupler may also be finely adjusted in order to suitably adapt the collimation of the first output diameter or to calibrate the overlapping of the second focus of the first element with the focus of the first output coupler (for example this may take place by way of a displacement/tilting of the first output coupler, for example by suitable positioners). However, it is important that in normal operation there may be no need for a calibration, since the system may be set up such that the optimal position between the first element and the first output coupler does not change, even if for example the wavelength and/or magnification of the system is changed.

In one example, the system is also set up such that the first output diameter is dependent on a numerical aperture of the photon beam focused into the first focus. The system may therefore be purposefully designed such that a predetermined numerical aperture of the photon beam focused into the first focus can be determined for a desired first output diameter. There can accordingly be in the system a direct relationship between the numerical aperture of the photon beam focused into the first focus and the first output diameter. For example, the system may be designed in such a way that there is a predetermined first output diameter, based on a predetermined numerical aperture of the photon beam in the first focus. The defined application of the numerical aperture may be caused in a predetermined manner for example by the design of various optical elements of the system that conduct the photon beam in a predefined manner with a desired numerical aperture into the first focus of the first element. Examples of this are described below.

In one example, the system is also set up such that the first output diameter is dependent on an angle of incidence at which the focused photon beam is focused into the first focus. The system can accordingly be specifically designed such that a predetermined angle of incidence of the photon beam focused into the first focus can be determined for a desired first output diameter. The angle of incidence of the photon beam into the first focus can in this case be defined with respect to a line or a plane of the first element. For example, the angle of incidence may be defined with respect to the line resulting from the connection of the first and the second focus of the first element (or the angle of incidence may also relate to a plane made to span over the first and second focuses). The angle of incidence may for example be defined with respect to a directional beam of the photon beam.

The inventor has thereby recognized a system arrangement with which, even when there is a (substantially) constant numerical aperture of the photon beam at the first focus, there may be a direct relationship between the angle of incidence of the photon beam at the first focus and the first output diameter. This is based on the fact that the system arrangement has the effect that the numerical aperture at the first focus (herein referred to as the first numerical aperture) also causes a numerical aperture of the photon beam at the second focus (herein referred to as the second numerical aperture). The system arrangement may in this case be constructed in such a way that, even with a constant first numerical aperture, the angle of incidence at the first focus has a direct relationship with the magnitude of the second numerical aperture. The system can accordingly allow a numerical aperture to be modulated. For example, in the case of a constant first numerical aperture, the second numerical aperture can be specifically set by a variation or a predetermined angle of incidence. Depending on the angle of incidence, the second numerical aperture can in this case be set differently from the first numerical aperture (for example larger or smaller than or equal to the first numerical aperture). The system arrangement can in this case allow in turn the dimension of the second numerical aperture to be able to be directly related to the first output diameter. For example, depending on the dimension of the second numerical aperture of the photon beam, the first output coupler can cause a corresponding dimension of the first output diameter. There is therefore a system in which the angle of incidence at which the focused photon beam is focused into the first focus allows a modulation of the second numerical aperture, while the modulation of the second numerical aperture can subsequently define the first output diameter. For example, the system may be designed such that there is a predetermined first output diameter, based on a predetermined angle of incidence of the photon beam into the first focus. The defined application of the angle of incidence may be caused for example by the design of various optical elements of the system which conduct the photon beam in a predefined manner with the desired angle of incidence into the first focus of the first element. Examples of this are described below.

In one example, the system also has a means for varying the numerical aperture of the photon beam focused into the first focus and/or the angle of incidence at which the focused photon beam is focused into the first focus. As described herein, the dependence of the output diameter of the photon beam on the first numerical aperture and the angle of incidence may therefore not only be static, but may be variably used during operation of the system. The varying may comprise that at least two numerical apertures of the photon beam focused into the first focus can be set for the operation of the system. Furthermore, the varying may comprise that at least two angles of incidence at which the focused photon beam is focused into the first focus can be set for the operation of the system. This variation may comprise for example that a mode which causes a desired output diameter can be specifically set in the system. Thus, the varying may comprise that at least two output diameters of the photon beam are set. For example, the angle of incidence (and/or the first numerical aperture) may be set to one of at least two predetermined values. Operation of the system in a mode may subsequently take place for example statically, so that the photon beam is outcoupled with the set (constant) output diameter (for example no further variation of the first numerical aperture and/or the angle of incidence takes place during the outcoupling). In another example, however, it is also conceivable that the variation takes place dynamically during the outcoupling of the photon beam. The output diameter (or the first numerical aperture and/or the angle of incidence) may in this case be varied for example with a frequency.

For example, the system may have a user interface which allows an output diameter to be specified. The system can then automatically set the numerical aperture and/or angle of incidence to provide the specified output diameter.

In one example, the system also has a first input coupler. The system may be set up such that the photon beam is received as collimated at the first input coupler with an input diameter. The first input coupler may be set up such that it focuses the photon beam onto the first focus (of the first element) by reflection at the first input coupler when the reception is collimated. For example, the first input coupler, the first element, and the first output coupler can be understood as parts of a first subsystem of the system. The collimated photon beam with the input diameter can in this case be understood as the input (or input signal) of the first subsystem. The collimated photon beam with the first output diameter can in this case be understood as the output (or output signal) of the first subsystem.

The first input coupler may for example have a curved and reflective surface, which receives the collimated photon beam with the input diameter, so that the collimated photon beam is reflected at the curved surface of the first input coupler in such a way that the photon beam is focused onto the first focus. In an example, the curved surface of the first input coupler may comprise a (locally different) concave region with respect to the incident collimated photon beam. The geometry of the curved surface can be mathematically described for example by a parabola (for example by a parabolic curve/surface). In one example, the first input coupler comprises a parabolic mirror. The parabolic mirror may in this case have the concave region at least along one plane. For example, the parabolic mirror may have a concave region exclusively along one plane. In another example, the parabolic mirror may have a concave region along each of two orthogonal planes.

In one example, the first element and the first input coupler are arranged in relation to one another such that a focus of the first input coupler and the first focus of the first element are substantially in the same position.

In one example, the first element and the first input coupler may be arranged positionally fixed in relation to one another. Thus, the first element and the first input coupler may be configured as relatively immovable in relation to one another, which means that the complexity of the adjustment in the system for adapting the photon radiation is reduced. This arrangement, given by way of example, can thus allow the photon beam to be precisely diverted into the first focus of the first element, and therefore also correspondingly precisely into the second focus of the first element, while no adjustment is required in this example to implement this.

It should be mentioned that in another example the first input coupler may also be finely adjusted to adapt the focusing suitably to the first focus or to calibrate the overlapping of the second focus of the first element with the focus of the first input coupler (for example this may take place by way of a displacement/tilting of the first input coupler, for example by suitable positioners). It is also important here that in normal operation there may be no need for a calibration, since the system may be set up such that the optimal position between the first element and the first input coupler does not change, even if for example the wavelength and/or magnification of the system is changed.

In another example, the system has a first input coupler, with the first input coupler being set up to receive the photon beam as collimated in an input diameter and to focus the photon beam onto the first focus without reflection. In one example, the first input coupler may comprise for example a focusing lens, a focusing lens system and/or an optical focusing device.

In one example, the means for varying may be set up such that it can direct the received collimated photon beam (in the input diameter) onto different segments of a surface of the first input coupler. By directing the received collimated photon beam onto different segments in this way, different angles of incidence of the photon beam onto the first focus can be set. A predetermined segment may in this case be associated with a predetermined angle of incidence. The effect of setting the angle of incidence can occur during reflection at the first input coupler in that the received collimated photon radiation is focused into the first focus of the first element independently of the irradiated segment. However, the spatial separation of the irradiated segments results in spatially offset starting points of the reflected edge beams of the photon radiation on the surface of the first input coupler. By focusing onto the first focus, however, these (initially spatially offset) edge beams all converge into the first focus, so that different angles of incidence result for differently irradiated segments. The means for varying may in this case be set up for example to direct the received collimated photon beam onto different segments of the surface of the first input coupler by way of a displacement (for example a parallel displacement) of the same. This may be implemented for example with a movable mirror. The means for varying may in this case comprise means for displacing the received collimated beam (for example a movable mirror, for example a flat mirror without curvature). For example, the movable mirror (as a means for displacing) may only be displaceable along one axis, so that only a parallel displacement of the received collimated photon beam is possible and necessary to irradiate the segments of the first input coupler. This can allow particularly easy adjustment and structural design. In other examples, the means for displacing may be movable and/or pivotable in two axes and/or three axes.

In one example, the system is also set up such that the first output diameter is greater than or equal to the diameter of the input diameter. The system (as described herein) can accordingly be set in such a way that the collimated photon beam with the input diameter undergoes such an adaptation that the first output diameter of the photon beam is higher by a certain factor than the input diameter. The system can therefore be used as a beam expander. For example, this can be made possible by the system being set up or set as described herein, so that the second numerical aperture is larger than the first numerical aperture, which can be implemented for example by way of a suitable angle of incidence at the first focus.

In one example, the system is also set up such that at least two increases in the first output diameter with respect to the input diameter can be set. The system can therefore be operated in at least two magnification modes, with each magnification mode being accompanied by a certain magnification. Operation of the system in a magnification mode may take place for example statically, so that the photon beam is outcoupled with the set (constant) magnification (for example no further variation of the magnification takes place during the outcoupling). In another example, however, it is also conceivable that the magnification takes place dynamically during the outcoupling of the photon beam. The magnification may in this case be varied between different values for example with a frequency.

In one example, the system is also set up such that the increase in the first output diameter with respect to the input diameter comprises a factor of at least 1.4, preferably at least 1.7, more preferably at least 2.2, most preferably at least 3.2 or at least 4. For example, the increase may also comprise at least the mathematical root of two, preferably at least the root of three, more preferably at least the root of five, most preferably at least the root of ten. The system may be set up such that it can vary the magnification in a range from for example 1 to at least 3.2 or from for example 1 to at least 4 or from 1 to at least 10.

The system may be set up to continuously vary the magnification, for example within the specified ranges. Alternatively or in addition, it may also be set up to allow at least two magnifications to be set as discrete values, for example it may be provided that it is possible to switch discretely from at least one magnification value to at least one other magnification value, which may be for example significantly greater or smaller.

In one example, the system is also set up such that the first output diameter is smaller than the diameter of the input diameter. The system (as described herein) can accordingly be set in such a way that the collimated photon beam with the input diameter undergoes such an adaptation that the first output diameter of the photon beam is smaller by a certain factor than the input diameter. The system can therefore be used as a beam reducer. For example, this can be made possible by the system being set up or set as described herein, so that the second numerical aperture is smaller than the first numerical aperture, which can be implemented for example by way of a suitable angle of incidence at the first focus.

In one example, the system is also set up such that at least two reductions of the first output diameter with respect to the input diameter can be set. The system can therefore be operated in at least two reduction modes, with each reduction mode being accompanied by a certain reduction. Operation of the system in a reduction mode may take place for example statically, so that the photon beam is outcoupled with the set (constant) reduction (for example no further variation of the reduction takes place during the outcoupling). In another example, however, it is also conceivable that the reduction takes place dynamically during the outcoupling of the photon beam. The reduction may in this case be varied between different values for example with a frequency.

In one example, the system is also set up such that the reduction in the first output diameter with respect to the input diameter comprises a factor of at least 1.4, preferably at least 1.7, more preferably at least 2.2, most preferably at least 3.2 or at least 4. For example, the reduction may also comprise at least the mathematical root of two, preferably at least the root of three, more preferably at least the root of five, most preferably at least the root of ten. The system may be set up such that it can vary the reduction in a range from for example 1 to at least 3.2 or from for example 1 to at least 4 or from 1 to at least 10.

The system may be set up to continuously vary the reduction, for example within the specified ranges. Alternatively or in addition, it may also be set up to allow at least two reductions to be set as discrete values, for example it may be provided that it is possible to switch discretely from at least one reduction value to at least one other reduction value, which may be for example significantly greater or smaller.

In another example, the first input coupler and the first element and the first output coupler are arranged positionally fixed in relation to one another. In one example, this system can in this case be controlled (only) by the means for displacing, which directs the received collimated photon beam with the input diameter onto the first input coupler (as described herein). In an example, the input diameter of the received collimated photon beam can therefore be adapted by a mere parallel displacement of the means for displacing to one or more first output diameters. There is therefore no need to implement complex mechanics for the adaptation of the beam diameter, which can reduce control and calibration requirements, so that the system complexity is reduced and in this case the optical quality of the photon radiation is ensured.

In one example, the system also comprises a second element with a curved surface which has a first and a second focus. The system may be set up such that the photon beam reflected at the first element is focused into the first focus of the second element, so that the photon beam is focused onto the second focus of the second element after reflection at the surface of the second element. This example should be understood here as meaning that the second element receives a photon beam which has already been conducted or deflected by way of the first element (as described herein), i.e. a photon beam which has previously been reflected at the first element. This example should also be understood here as meaning that the photon beam between the first and the second element could be exposed to further influences or one or more optical elements (for example the first output coupler). The second element may therefore be arranged behind the first element on the basis of the beam direction of the path of the photon radiation. The properties (or characteristics) of the second element may in this case correspond to the properties (or characteristics) of the first element described herein (and vice versa). In an example, the structure of the first and the second element in the system is (substantially) the same. For example, the first and the second element may be constructed in the same way, whereby the same optical properties of the first and the second element may be present. The second element may in this case represent a second deflecting unit in the system, which conducts or deflects the photon beam from the first focus of the second element onto the second focus of the second element. In one example, the photon beam collimated by the first output coupler with the first output diameter is focused into the first focus of the second element, so that it is focused onto the second focus of the second element.

In one example, the system also comprises a second output coupler, which collimates the photon beam to a second output diameter after reflection at the second element. The properties (or features) of the second output coupler may in this case correspond to the properties (or features) of the first output coupler described herein (and vice versa). In one example, the structure of the first and the second output coupler is (substantially) the same.

In another example, the second output coupler comprises an output coupler which collimates the photon beam to the second output diameter without reflection. In this example, the second output coupler may comprise for example a collimating lens, a collimating lens system, and/or a collimator, which does not necessarily have to comprise reflective elements.

In one example, the second element and the second output coupler are arranged in relation to one another such that a focus of the second output coupler and the second focus of the second element are substantially in the same position.

In one example, the system also comprises a second input coupler, with the second input coupler being set up to receive the photon beam collimated by the first output coupler and to focus it onto the first focus of the second element by reflection at the second input coupler. The properties (or features) of the second input coupler may correspond to the properties (or features) of the first input coupler described herein (or vice versa). In one example, the structure of the first and the second input coupler is (substantially) the same.

The second input coupler, the second element and the second output coupler can in this case be understood as parts of a second subsystem of the system. The collimated photon beam with the first output diameter may in this case be understood for example as an input (or input signal) of the second subsystem. The collimated photon beam with the second output diameter may in this case be understood as the output (or output signal) of the second subsystem. The output of the second subsystem may in this case act as the output of the system. In one example, the parts of the second subsystem may correspond to the same structure of the parts of the first subsystem.

The second subsystem (or one or more parts of the second subsystem) may in this case fulfill the functions as described herein for parts of the first subsystem. The second subsystem may therefore serve to further adapt the collimated photon beam with the first output diameter according to the mechanisms of the first subsystem. For example, the second subsystem may further increase the first output diameter, so that the second output diameter is greater than the first output diameter. The total magnification of the first and second subsystems may for example result from the multiplication of the magnifications of the first subsystem by the magnification of the second subsystem. In another example, the second subsystem may also be set up merely as a deflecting unit without a magnification function.

Splitting the magnification between two subsystems can for example reduce the requirements for the production of the first or (if necessary identical) second element. For example, smaller curvatures may then be sufficient.

In one example, the second element may be set up to compensate at least partially for an unsymmetrical light distribution of the photon beam reflected by the first element. For example, depending on the angle of incidence at the first focus of the first element, a certain unsymmetrical light distribution of the partial beams of the photon beam reflected by the first element can occur (i.e. the partial beams of the bundle of light of the photon beam reflected by the first element). This may be caused by the different reflection angles of the partial beams of the photon beam at the first element, so that the distances of the partial beams vary across the photon beam after the reflection at the first element. For example, this may occur if the second numerical aperture (at the second focus of the first element) is different from the first numerical aperture (at the first focus of the first element). The inventor has recognized that this actually parasitic effect in the reflection of the photon beam at the first element can be used specifically for compensation when the photon beam with the unsymmetrical light distribution is again focused and reflected at an element that has similar reflective properties to the first element. According to the invention, the reflection at the second element can be used for this purpose. For this purpose, it may be helpful that the system is set up in such a way that the arrangement of the edge beams of the photon beam is reversed when focusing onto the second element, as compared with the arrangement of the edge beams when focusing onto the first element. The edge beam which, during the reflection at the first element, is closer to its second focus may for example be further away from the second focus during the reflection at the second element. It can in this way be ensured that the described effect in the reflection of the photon beam at the second element drives together the partial beams of the photon beam which, due to the asymmetry, are at greater distances from one another. Furthermore, it can in this case also be ensured that the partial beams of the photon beam which, due to the asymmetry, are at comparatively smaller distances from one another are driven apart. The end result is that the light distribution of the photon beam which has been reflected at the first and the second element can comprise a (substantially) symmetrical light distribution of the partial beams, or the unsymmetrical light distribution can be noticeably compensated to a certain degree. Moreover, the system may be set up such that the photon beam is directed onto regions of the first or the second element that have a similar curvature, so that the compensation is optimized. It should also be noted that, if the arrangement of the edge beams in the system is not reversed—as explained—the unsymmetrical light distribution caused by the reflection at the first element may be further intensified during the reflection at the second element. Using the second element as a means for compensating the unsymmetrical light distribution can accordingly make it possible to provide a system for adapting a diameter of the photon radiation which has no noticeable distortion properties and yet can be controlled with low complexity.

In some examples, it may be provided that the elements of the second subsystem are a factor larger than the corresponding elements of the first subsystem, but otherwise have the same form. The factor may for example correspond to a medium magnification achievable by the first subsystem. For example, if the first subsystem can achieve a certain maximum magnification Vmax, the elements of the second subsystem may for example be made larger by a factor of Vmax/2. When using the magnification Vmax/2 in the first subsystem, the photon beam could then pass identically through the correspondingly enlarged mirror surfaces in the second subsystem (where it is magnified by Vmax/2), although the displacement of the symmetry of the light distribution could be compensated practically identically.

In other examples, more than two of the subsystems mentioned may also be used. These may in each case possibly increase in the size of their corresponding elements.

A second aspect concerns a device for projecting with a system according to one of the examples described herein. The device may comprise for example a replication apparatus, an exposure apparatus, a printer and/or some other projection device. The photon beam with the first output diameter and/or the photon beam with the second output diameter may for example correspond to a field point or a part of an image which is intended to be depicted by the device in a plane. For this purpose, the device may have a corresponding light source, the collimated beam of which can then be adapted in diameter. Alternatively or additionally, the device may have one or more (movable) reflective elements in order to be able to scan the photon beam, for example along one or two orthogonal directions. The device may also have one or more parabolic mirrors in order to direct into a desired plane the scanned beam that has been adapted in diameter.

As described herein, the system can avoid an aberration which is typically associated with passing/transmitting a photon beam through two media (for example in the case of a lens). For example, a corresponding aberration in the device for projecting, which comprises the system, can therefore likewise be avoided. For example, color errors (for example a chromatic aberration) can be avoided, so that the device for projecting can function reliably for different wavelengths of the photon radiation. For example, a replication apparatus can be operated without (significant) color errors. For example, freedom from aberrations can be provided substantially over a wavelength range from 400 nm to 800 nm (and/or in another wavelength range as described herein).

A third aspect concerns a method for adapting a diameter of a photon beam comprising: directing an incident photon beam onto a first element comprising a curved surface, with the first element having a first and a second focus. The directing takes place in such a way that the received photon beam is focused into the first focus of the first element, with the directed photon beam being output as focused at the second focus after reflection at the surface of the first element. The method may also comprise collimating the photon beam reflected at the first element to a first output diameter. The method may in this case be carried out with a system according to one of the examples of the first aspect described herein.

In one example of the method, the incident photon beam comprises a collimated photon beam with a first input diameter, with the directing also comprising:
varying a numerical aperture of the photon beam focused into the first focus and/or an angle of incidence at which the focused photon beam is focused into the first focus, so that the first output diameter varies.

A fourth aspect concerns a computer program comprising instructions which, when executed by a computer, a system according to the first aspect and/or a device according to the second aspect, cause the computer, the system or the device to carry out a method according to the third aspect.

Alternatively or additionally, the computer program may have instructions for carrying out the further method steps described herein or for carrying out or implementing the functionalities of devices described herein. For example, the computer program may cause certain optical elements of the system to displace (for example components of the means for displacing), resulting in an optical magnification or zoom factor selected in the program for the system or device. The system can therefore be controlled on the basis of a computer program and an interface to its optical elements.

A further aspect concerns the system mentioned and/or the device with a memory which comprises the computer program. The system and/or device may also have means for executing the computer program. Alternatively, it is also possible that the computer program is stored elsewhere (for example in a cloud) and that the device merely has means for receiving instructions that arise from executing the program elsewhere. Either way, it may for example be made possible thereby that the method can run in automated or autonomous fashion within the system and/or device. Therefore, intervention, for example by means of a manual adjustment, can be minimized, so that the complexity involved in the adaptation of the beam diameter can be reduced.

The features (and also examples) of the method specified herein may also be applied or applicable correspondingly to the system (or the device and/or the computer program) mentioned. Similarly, the features (and also examples) of the system or device specified herein may also be applied or applicable correspondingly to the methods or computer programs described herein.

### 4. BRIEF DESCRIPTION OF THE FIGURES

The detailed description that follows describes technical background information and exemplary embodiments of the invention with reference to the figures, which show the following:

FIG. 1 schematically illustrates in a side view a system of the invention, shown by way of example, for adapting a diameter of a photon radiation.

FIG. 2 schematically shows the beam distribution of the photon radiation as it passes through a system of the invention shown by way of example.

FIG. 3 schematically illustrates in a side view another system of the invention shown by way of example.

### 5. DETAILED DESCRIPTION OF THE FIGURES AND POSSIBLE EMBODIMENTS

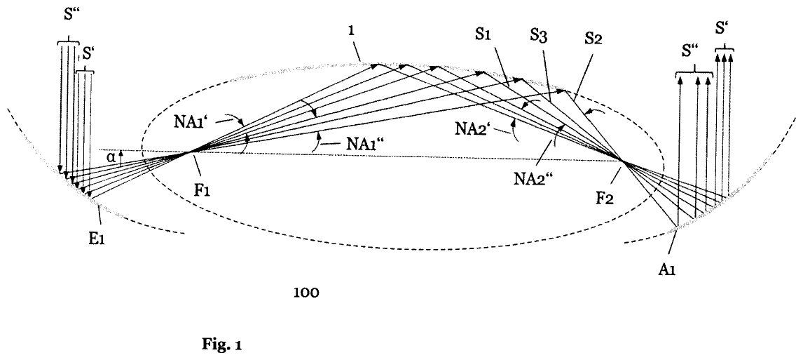

FIG. 1 schematically illustrates in a side view a system 100, shown by way of example, for adapting a diameter of a photon radiation. The system 100 may in this case be designed for the adaptation of a photon radiation with any wavelength. For example, the photon radiation may comprise the light range visible to humans. For example, the photon radiation may in this case lie in a wavelength range of 400 nm to 800 nm (which includes the RGB color space). However, it is also conceivable that the concepts or features of the system 100 and the invention mentioned herein can also be applied to photon radiation in the (E and/or D) UV range and/or the (near) infrared range. Only a reflectivity of the respective reflecting surfaces of the system in the respective wavelength range must be provided. Irrespective of the respective wavelength range, the photon beam may be provided for example as a laser beam. The use of the word beam does not imply that it can be a continuous wave beam. Both a continuous wave photon beam and for example a pulsed photon beam can be used.

The system 100 in FIG. 1 may comprise a first element 1 for adapting the photon radiation. The first element 1 may in this case have a first focus F1 and a second focus F2. In an example, the first focus F1 and the second focus F2 may be designed such that a photon radiation which emanates from one focus and is reflected at the first element 1 subsequently enters the other focus. The photon radiation from one focus can therefore be projected onto the other focus. In one example, the first element 1 comprises an elliptical mirror, with the first focus F1 and the second focus F2 corresponding to the two focuses of the elliptical mirror. The elliptical mirror may in this case comprise a portion of a geometric ellipse, i.e. the ellipse of the elliptical mirror does not have to be completely formed geometrically. This can be seen for example in FIG. 1, with the first element 1 representing an elliptical mirror which is constructed from a partial portion of the ellipse represented by dashed lines.

The system 100 may also comprise a first input coupler E1. The first input coupler E1 can be used to receive a photon beam and to focus it onto the first focus F1 of the first element 1. The photon beam received at the first input coupler E1 can also be understood as an input of the system 100. In an example, the first input coupler E1 may be set up to receive a collimated photon beam which is collimated to a defined diameter, while this diameter can also be referred to as the input diameter. For the description of the system 100, reference is first made, by way of example, to the beam path of the first photon beam S′, which is incident with the input diameter on the first input coupler E1. The first photon beam S′ may in this case comprise a radiation beam which comprises a number of partial beams, with the edge beams and the directional beam being shown in FIG. 1. The first photon beam S′ is in this case first incident on the first input coupler E1 as a collimated input beam with an input diameter. The first input coupler E1 may comprise for example a parabolic mirror (as shown in FIG. 1). The parabolic mirror may comprise a portion of a geometric parabola, i.e. the parabola of the parabolic mirror does not have to be completely formed geometrically. This can be seen for example in FIG. 1, with the first input coupler E1 representing a parabolic mirror which is constructed from a partial portion of the parabola represented by dashed lines. To focus the received photon radiation S′, the first input coupler E1 (for example the parabolic mirror) may have a focus that is aligned with the first focus F1 of the first element. The position of the focus of the first input coupler E1 may substantially correspond to the position of the first focus F1 of the first element, so that these focuses spatially overlap completely (or at least partially). In the case of a parabolic mirror as the first input coupler E1, it should be mentioned that axially parallel beams, i.e. beams that are incident parallel to the ordinate (or the axis of symmetry or a guide line) of the geometrically/mathematically definable parabola, enter the focus of the parabolic mirror after the reflection at the parabolic mirror. The system 100 may accordingly be arranged in such a way that, when formed as a parabolic mirror, the first input coupler E1 receives the collimated first photon radiation S′ with the input diameter in this manner parallel to the axis, so that the received photon radiation is (mainly) diverted into the focus of the parabolic mirror. The first photon radiation S′ coupled in parallel to the axis may in this case comprise a planar wavefront. Since the focus of the first input coupler E1 (or the focus of its parabolic mirror) lies at the same position as the first focus F1 of the first element, the first photon radiation S′ is therefore automatically focused with the input diameter onto the first focus F1 of the first element 1. This photon radiation can subsequently be reflected at the first element 1, to then be focused into the second focus F2 of the first element 1. This defined “refocusing” can accordingly be used for deflecting a photon radiation in the system 100 or a system of the invention.

The system 100 may also comprise a first output coupler A1. The first output coupler A1 may in this case comprise for example a parabolic mirror (as shown in FIG. 1). The parabolic mirror may comprise a portion of a geometric parabola, i.e. the parabola of the parabolic mirror does not have to be completely formed geometrically. This can be seen for example in FIG. 1, with the first output coupler A1 representing a parabolic mirror which is constructed from a partial portion of the parabola represented by dashed lines. The first output coupler A1 may be set up to receive the radiation focused by the first element 1 at the second focus F2 and to collimate it to a first output diameter. For this purpose, the first output coupler A1 (for example constructed as a parabolic mirror) may have a focus that is aligned with the second focus F2 of the first element. In this case, the position of the focus of the first output coupler A1 may substantially correspond to the position of the second focus F2 of the first element, so that these focuses spatially overlap completely (or at least partially). In the case of a parabolic mirror as the first output coupler A1, it should be mentioned that focus beams, i.e. beams that emanate from the focus of the parabola and are incident on the surface of the parabolic mirror, are coupled out from the parabolic mirror in parallel with the axis after the reflection at the parabolic mirror. The overlapping mentioned of the second focus F2 and the focus of the first output coupler A1 therefore allows this axially parallel outcoupling to be ensured. This makes it possible, as can be seen in FIG. 1, to “convert” the first photon beam S′ into a collimated beam again and to couple it out as a collimated output beam with a first output diameter. The first photon radiation coupled out parallel to the axis may in this case comprise a planar wavefront.

In the example in FIG. 1, the first output diameter of the first photon beam S′ is in this case equal to the input diameter of the photon beam S′. This is achieved by the fact that the photon beam S′ is substantially symmetrically incident on a region around the minor axis of the ellipse of the first element 1.

It should also be mentioned that in one example the parabolic mirror of the first input coupler E1 and the parabolic mirror of the first output coupler A1 can be described by the same parabola, just with different portions of the parabola (for example different legs of the parabola) being used for the first input coupler E1 and the first output coupler A1. The first input coupler E1 and the first output coupler A1 may be arranged symmetrically with respect to the first element 1. For example, the first input coupler E1 and the first output coupler may be arranged symmetrically with respect to a minor axis or major axis of the ellipse which is defined by the elliptical mirror of the first element 1.

As described, the system 100 can accordingly make it possible to divert the photon radiation in a targeted manner by a beam being transformed from a collimated state to a focused state, subsequently focused spatially offset and then returned to a defined collimated state without requiring a complex adjustment. The conversion of this deflecting unit by way of reflective elements (for example with the elliptical mirror as the first element 1, the parabolic mirror as the first input coupler E1 and/or the parabolic mirror as the first output coupler A1) can also make it possible that light transmission of the photon radiation through two media when it undergoes deflection in the system 100 can be avoided, so that corresponding aberration is likewise avoided (for example monochromatic and/or chromatic aberrations associated with lenses can be avoided).

For another example, a possible mechanism for adapting the diameter of the photon radiation in the system 100 is explained. The system 100 may for example be set up or used in such a way that the first output diameter of the photon beam coupled out at the first output coupler is greater than the input diameter of the photon beam coupled in at the first input coupler E1. For this magnification effect, reference is now made to the beam path of the second photon beam S″ shown in FIG. 1, in which the magnification effect occurs in contrast to the first photon beam S′. The second photon beam S″ may in this case comprise a radiation beam which comprises a number of partial beams, while in FIG. 1 the first edge beam S1, the second edge beam S2 and the directional beam S3 are marked. The second photon beam S″, axially parallel to the parabolic mirror of the first input coupler, in this case radiates onto a segment of the surface of the parabolic mirror of the first input coupler E1, so that the second photon beam S″ is focused onto the first focus F1 of the first element at a certain angle of incidence α. The irradiated segment of the first input coupler E1 is different in the case of the second photon beam S″ from the irradiated segment in the case of the first photon beam S′. A certain angle of incidence α is therefore obtained for the second photon beam S″, different from the angle of incidence of the first photon beam S′, with which there is no magnification effect. The angle of incidence can be defined in this example as the angle between the directional beam of a photon beam and the line connecting the first and the second focus of the first element (i.e., the major axis of the ellipse, although other definitions are also possible). The angle of incidence α results in a beam path which is further defined by the reflection of the second photon beam S″ at the first element 1 and the focusing onto the second focus F2. Due to the magnitude of the angle of incidence and the boundary conditions during the reflection at the first element 1, it is found that the numerical aperture NA2″ of the second photon beam S″ at the second focus F2 is larger than the numerical aperture NA1″ of the second photon beam S″ at the first focus F1. This larger second numerical aperture NA2″ is subsequently incident on the surface of the first output coupler. The first output coupler A1 subsequently collimates the second photon beam S″ to the first output diameter. By increasing the numerical aperture NA2″ at the second focus, it is shown in this example overall that the collimated output beam of the second photon beam S″ has a greater diameter than its collimated input beam.

In comparison, it should be mentioned that in the case of the first photon beam S′ no magnification effect occurs in the system 100, since there is no change in the numerical aperture during the reflection at the first element 1. Although the first (axially parallel) photon beam S′ has the same input diameter as the second photon beam S″, the first photon beam S′ irradiates a different segment of the parabolic mirror of the first input coupler E1, resulting in a different angle of incidence at the first focus F1, which specifically does not cause any change in the numerical aperture at the second focus. For the first photon beam S′, the numerical aperture NA1′ at the first focus F1 is accordingly equal to the numerical aperture NA2′ at the second focus F2. It should be noted that, for the first photon beam S′, the angle of incidence is in this case chosen in such a way that the directional beam S3 of the second photon beam S″ is incident on a vertex of the minor axis of the ellipse which is formed by the elliptical mirror of the first element 1. The resulting beam path of the first photon beam S′ is therefore symmetrical with respect to the two focuses F1 and F2 (or the minor axis), so that there is no change in the numerical aperture at the focuses F1 and F2. It should also be mentioned that, in the example of FIG. 1, the first input coupler E1 and the first output coupler A1 are arranged symmetrically with respect to the minor axis of the ellipse, so that, with the same numerical aperture NA1′ and NA2′ of the first photon beam S′, its input diameter is transformed directly to the first output diameter. In other words, the magnifying effect is caused by the “oblique” incidence of the second photon beam into the first element 1, so that the beam path no longer takes place symmetrically along the minor axis of the ellipse. The accompanying change of the numerical aperture at the focuses F1 and F2 can therefore be used to increase the output diameter of the photon beam with respect to the input diameter.

By “parallel displacing” of the incoming photon beam (for example by a mirror movable along an axis), the magnification of the system can therefore be varied.

It should be noted that a zoom system is typically defined from a magnification of 1/m to m. The zoom factor can be defined as: Γ=mₘₐₓ/mₘᵢₙ=m², where mₘₐₓ and mₘᵢₙ are typically the longest and shortest focal length of a zoom lens. In one example, the magnification of the system 100 can reach values that exceed the root of 10, for example greater than 4 (as already described herein). By the typical definition of a zoom lens, this accordingly corresponds to the magnification m of greater than root 10 (i.e. m at least ˜3.16), where the zoom factor m² is then at least m²=10. In other examples, the zoom factor of the system 100 is at least 2, 3, 5, or at least 20.

However, as indicated in FIG. 1, the magnification in the case of the second photon beam S″ leads to an unsymmetrical light distribution of the partial beams S1, S2, S3. Thus it is indicated that the partial beams S2 and S3 in the collimated output diameter are at a greater distance from one another than the partial beams S1 and S2. In the system 100, although a magnification is accordingly performed in the case of the second photon beam S′, an unsymmetrical light distribution of the partial beams is thereby introduced, which may for example represent a distortion. It should be mentioned here that, for the partial beams S1, S2, S3, there are different reflection angles at the first element 1. Thus for example, the edge beam S2 has the shortest distance of the partial beams from the second focus F2 after the reflection at the first element 1 and is therefore focused the “strongest” onto the second focus F2. The edge beam S1 has the longest distance of the partial beams from the second focus after the reflection at the first element 1 and is therefore focused the “weakest” onto the second focus F2.

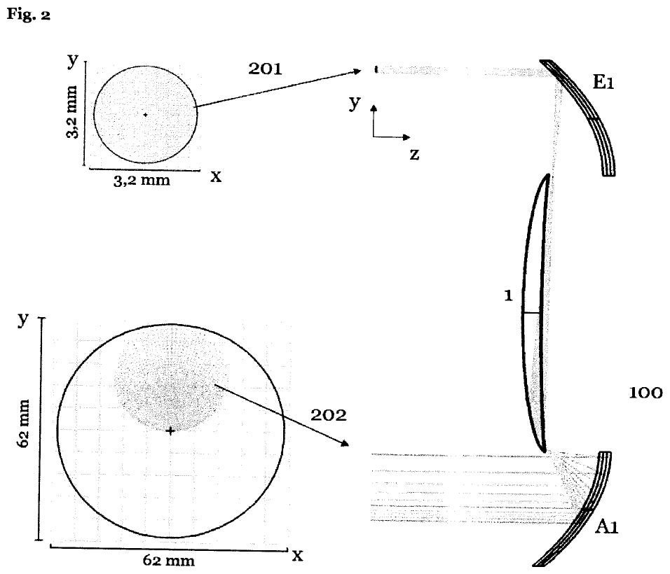

The effect of the unsymmetrical light distribution in the case of a magnification is explained in more detail in FIG. 2. FIG. 2 schematically shows the beam distribution of the photon radiation as it passes through the system 100 of the invention shown by way of example. The beam distribution or arrangement of the partial beams of the second photon beam S″ is in this case schematically illustrated on the basis of simulation results. Shown on the one hand is the input beam distribution 201 of the collimated input beam of the second photon beam S″ before the incoupling into the system 100. The input beam distribution 201 is in this case shown in the x and y directions, while the path of the partial beams in the system 100 is shown in the z and y directions. The input beam distribution 201 may for example correspond to the beam distribution of a homogeneous light source which is used as the source for the second photon beam S″. In this example, the input diameter of the collimated input beam is 3.2 mm, with the beam cross section being circular. It is also conceivable here to use any other form of beam cross section (for example rectangular, square, elliptical, etc.) as well as any other (largest) input diameter (for example at least 0.5 mm, at least 1 mm, at least 2 mm, at least 5 mm, and/or less than 10 mm, less than 5 mm, less than 2 mm, etc.). The output beam distribution 202 of the collimated output beam of the second photon beam S″ after passing through the system 100 with first element 1, input coupler E1 and output coupler A1 (which may be designed as described in relation to FIG. 1) is in this case shown in the x and y directions. It can be seen that in this case the first output diameter is approx. 30 mm, while by analogy with the input beam the beam cross section is circular. This accordingly indicates that, by way of example, the magnification in the system 100 has taken place in the x and y directions. In the example in FIG. 2, the incoupling (as described herein) accordingly takes place in such a way that a magnification factor of approx. ten occurs.

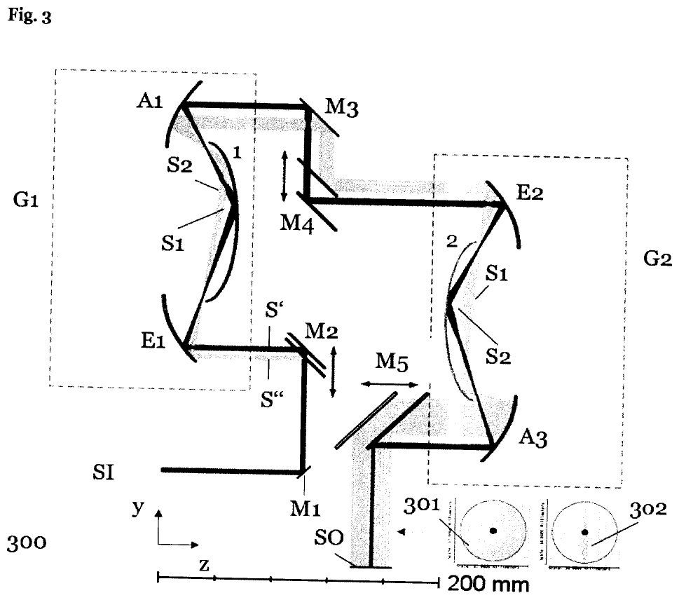

In an alternative example, the magnification may also only take place along one axis, for example the y axis. For this purpose, for example the mirrors of the first input coupler E1, the first element 1 and/or the first output coupler A1 may be produced as only curved in one dimension, so that the light can only be magnified in one dimension, for example the y axis. For example, the output beam would in this case be as wide in the x direction as the input beam in the x direction, while the diameter of the output beam in the y direction would be for example about ten times as large as the diameter of the input beam in the y direction (with a magnification factor of the system 100 of about ten). For this purpose, reference should also be made in advance to the beam distribution 302 in FIG. 3, which represents a corresponding beam distribution in the case of which the magnification only takes place along one axis. It can be seen that the enveloping form of the beam distribution 302 substantially represents an ellipse. Also in a system such as in FIG. 2, an output beam distribution of which the envelope substantially represents an ellipse can be generated by limiting the magnification along one axis (for example the y axis).

It should be noted that, according to the disclosure, a (substantially) symmetric beam magnification may therefore be generated (for example with an equal magnification along the x and y axes). Likewise, according to the disclosure, a (substantially) asymmetric beam magnification may be generated (for example with a magnification only along the y axis).

For certain applications, it may be necessary for example to generate a symmetrical beam magnification. It may be technically required here for example that the output beam is magnified symmetrically (as described herein). If for example the input beam has a (substantially) circular envelope of the intensity distribution, it may be required for example that the output beam also has a (substantially) circular envelope.

However, for certain applications it may also be necessary for example to generate an asymmetric beam magnification. It may be technically required for example that the output beam is magnified asymmetrically (as described herein). If for example the input beam has a (substantially) circular envelope of the intensity distribution, it may be required for example that the output beam has a (substantially) elliptical envelope. For example, this can ensure a higher light intensity of the output radiation, since the radiation is distributed (comparatively) over a smaller area than with a symmetrical magnification. For example, an asymmetric magnification may be advantageous when using the system in a projection device, while for example the elliptical output radiation can be further manipulated by way of the projection device. For example, the elliptical output radiation from the projection direction may be rasterized along a line.

The unsymmetrical light distribution of the partial beams (for the symmetrical magnification along the x and y axes) can also be read from FIG. 2, as can be seen from the greater distances of the partial beams at higher y values and the decreasing distances of the partial beams at lower y values. Also shown is the beam distribution in the y-z plane for ten partial beams, in which the asymmetry of the distances of the partial beams can likewise be seen schematically. No significant asymmetry can be seen here along the x axis (due to the optical structure). For example, this can be ensured by the fact that the beam path is formed symmetrically to the y-z plane.

FIG. 3 schematically illustrates in a side view another system 300 of the invention shown by way of example, which can compensate or minimize the asymmetry described with reference to FIG. 2. The system 100 described herein may in this case be included as a subsystem in the system 300. In FIG. 3 there can first be seen a photon beam input Si, which is diverted via a first deflecting mirror M1 to a first displacing mirror M2. The first displacing mirror M2 may in this case be displaced along the depicted y axis. The first displacing mirror M2 can be used to guide the photon beam input SI in a defined manner into a first subsystem G1, which may correspond to the system 100 in terms of structure and function. In this example, the first displaceable mirror M2 may introduce the photon beam input Si into the first subsystem G1, so that the first photon radiation S′ and also the second photon radiation S″ can be caused, depending on the position of the first displacing mirror M2. The displacing mirror can accordingly be understood as a means for varying, with more than two positions of the first displaceable mirror M2 being conceivable, while different photon radiations with different angles of incidence, and therefore magnifications, can be set for the first subsystem G1. In this respect, the first input coupler E1, the first element 1 and the first output coupler A1 of the first subsystem G1 (analogous to the system 100) can be seen in FIG. 3. From the first subsystem G1, the photon beam S′ (slightly magnified) or the photon beam S″ (more magnified, but also with a more unsymmetrical light distribution) can be coupled out with the first output diameter.

In the example from FIG. 3, this coupled-out photon radiation is subsequently diverted via a second deflecting mirror M3 to a second displacing mirror M4. The second displacing mirror M4 can be used to guide the photon radiation coupled out from the first subsystem G1 in a defined manner into a second subsystem G2 of the system 300. The second subsystem G2 may correspond to the system 100 in terms of structure and function. In this respect, a second input coupler E2, a second element 2 and a second output coupler A2 of the second subsystem G2 (analogous to the system 100 and the subsystem G1) can be seen in FIG. 3. In particular, here too the second displacing mirror M4 can adapt the radiation coupled out from the first subsystem G1 in such a way that it is incident on different segments of the surface of the second input coupler E2, so that different angles of incidence, and therefore accompanying magnifications, can be introduced to the photon radiation in the system 300 (as described herein). In one example, the second displacing mirror M4 and the first displacing mirror M2 may be coupled to one another. The coupling may in this case be designed in such a way that the first and second displacing mirrors M2, M4 for each subsystem G1, G2 cause the same magnification. In the example shown in FIG. 3, the coupling may in this case be such that the second displacing mirror M4 always moves in the same direction as the first displacing mirror M2, for example so that the photon beam is directed onto a segment of the second input coupler E2 which corresponds to the segment of the first input coupler E1 onto which the photon beam was directed. In this case, however, the second displacing mirror M4 may travel a multiple distance than in the comparison the first displacing mirror M2 (as indicated in FIG. 3, the displacing mirror M4 for the photon beam S″ is displaced further than in the comparison the displacing mirror M2, with respect to the mirror position in order to divert the photon beam S′). For example, when there is a displacement of the first displacing mirror M2, the second displacing mirror M4 may travel a distance which is greater by a certain multiplicative factor than the distance that the first displacing mirror M2 travels. The zoom factor of the system 300 can accordingly be set over a single degree of freedom of movement and yet (at almost any wavelength) can be varied substantially without aberrations over a large range.

The total magnification of the system 300 can therefore be obtained from the multiplication of the magnification introduced at the first subsystem G1 by the magnification introduced at the second subsystem G2. The second subsystem G2 can therefore be regarded as a further magnification unit. The total magnification of the system 300 may comprise for example at least 5, at least 10 or at least 20, though higher total magnifications would also be conceivable. It is also conceivable that the system 300 comprises a zoom factor of at least 2, preferably at least 10, more preferably at least 50, most preferably at least 100.

In addition, the second subsystem G2 may however also (at the same time) compensate for the asymmetry of the light distribution which can occur with the magnification of the photon beam in the first subsystem G1 (as described herein). It should be mentioned that for this purpose the components in the system 300 should be configured for such a beam path in which the arrangement of the edge beams S1, S2 in the second subsystem G2 is reversed with respect to the arrangement of the edge beams S1, S2 in the first subsystem G1. The arrangement of the edge beams can in this case be considered to be reversed with respect to the incoupling of the edge beams into the respective subsystem. This is schematically shown in FIG. 3, in which the edge beams S1 and S2 are marked. In the first subsystem G1, the edge beam S1 is located in the portion between the focus of the first input coupler E1 and its reflection point at the first element 1 on the side of the photon beam S″ which is facing the first element 1. In the second subsystem G2, on the other hand, the edge beam S2 is located in the portion between the focus of the second input coupler E2 and its reflection point at the second element 2 on the side of the photon beam S″ which is facing the second element 2. This reversal of the edge beams S1, S2 when entering the second subsystem G2 can be explained for example in that, as a result of the beam path of the system 300, the photon radiation enters the second subsystem G2 mirrored, compared with when the photon radiation enters the first subsystem G1. This type of configuration can make it possible that the effect of the unsymmetrical light distribution of the first subsystem G1 is compensated (at least partially) by way of the second subsystem G2. This can be explained by the fact that the effect that causes the asymmetry of the distribution of the partial beams acts in the opposite direction in the second subsystem G2 due to the reflection of the photon radiation, so that the asymmetry of the distribution of the partial beams is minimized after passing the second subsystem G2. If the compensation mentioned does not take place, the parasitic effect described herein will increase the asymmetry of the light distribution still further.

The system 300 also comprises, after the second subsystem G2, a third displacing mirror M5, which is displaceable along the z direction. The third displacing mirror can therefore adapt the position of the photon beam coupled out from the second subsystem G2 on one plane. The photon beam coupled out from the system 300 may in this case also be referred to as the photon beam output SO. For example, depending on the magnification caused by the system 300, the third displacing mirror M5 can assume a position such that the photon beam output SO emitted by the system 300 appears centered on a point irrespective of the magnification.

The possible photon beam output SO of the system 300 is in this case given by way of example with the beam distribution 301 and the beam distribution 302.

The beam distribution 301 indicates the beam distribution in the case of a magnification and compensation of the photon beam input SI by way of the system 300 in the x and y directions. For the beam distribution 301 there is therefore a symmetrical beam magnification (as described herein). The symmetrical beam magnification may for example be present in both subsystems, so that as a result the photon beam output SO has a symmetrical beam magnification.

The beam distribution 302 in this case indicates the beam distribution in the case of a magnification and compensation of the photon beam input SI by way of the system only in the y direction. For the beam distribution 302 there is therefore an asymmetric beam magnification (as described herein). Thus, it can be seen that the envelope of the beam distribution 302 has an elliptical form (in contrast to the circular distribution of the radiation of the photon beam input SI, which is indicated in darker color). The asymmetric beam magnification may for example be present in both subsystems, so that as a result the photon beam output SO has an asymmetric beam magnification.

1. A system for adapting a diameter of a photon beam, comprising:
a first element with a first curved surface which has a first focus and a second focus,
wherein the system is configured such that the photon beam is focused into the first focus, so that the photon beam is focused onto the second focus after reflection at the first curved surface of the first element.

2. The system as claimed in claim 1, wherein the system further comprises a first output coupler, which collimates the photon beam to a first output diameter after reflection at the first output coupler.

3. The system as claimed in claim 2, wherein the first element and the first output coupler are arranged in relation to each other such that a focus of the first output coupler and the second focus of the first element are substantially in the same position.

4. The system as claimed in claim 2, wherein the first element and the first output coupler are arranged positionally fixed in relation to one another.

5. The system as claimed in claim 2, wherein the first output diameter is dependent on a numerical aperture of the photon beam focused into the first focus.

6. The system as claimed in claim 2, wherein the first output diameter is dependent on an angle of incidence at which the photon beam is focused into the first focus.

7. The system as claimed in claim 5, further comprising a means for varying the numerical aperture of the photon beam focused into the first focus and/or an angle of incidence at which the photon beam is focused into the first focus.

8. The system as claimed in claim 1, further comprising a first input coupler,
wherein, when a collimated photon beam is received, the first input coupler focuses the collimated photon beam with an input diameter onto the first focus by reflection at the first input coupler.

9. The system as claimed in claim 8, wherein the collimated photon beam is directed onto different segments of a surface of the first input coupler.

10. The system as claimed in claim 2, wherein the first output diameter is greater than an input diameter of a collimated photon beam.

11. The system as claimed in claim 10, wherein the system is configured to allow at least two increases in the first output diameter with respect to the input diameter.

12. The system as claimed in claim 10, wherein an increase in the first output diameter with respect to the input diameter is by a factor of at least 1.4.

13. The system as claimed in claim 8, wherein the first element and the first input coupler are arranged positionally fixed in relation to each other.

14. The system as claimed in claim 1, wherein the first element comprises an elliptical mirror.

15. The system as claimed in claim 1,
wherein the system further comprises a second element with a second curved surface including a third focus and a fourth focus, and
wherein the photon beam reflected at the first element is focused into the third focus of the second element, so that the photon beam is focused onto the fourth focus of the second element after reflection at the second curved surface of the second element.

16. The system as claimed in claim 15, wherein the system further comprises a second output coupler, which collimates the photon beam to a second output diameter after reflection at the second element.

17. The system as claimed in claim 16, wherein the second element and the second output coupler are arranged in relation to each other such that a focus of the second output coupler and the second focus of the second element are substantially at the same position.

18. The system as claimed in claim 15, wherein the system further comprises a first output coupler and a second input coupler
wherein the second input coupler is configured to receive the photon beam collimated by the first output coupler and to focus the photon beam onto the third focus of the second element by reflection at the second input coupler.

19. The system as claimed in claim 15, wherein the second element is configured to compensate at least partially for an unsymmetrical light distribution of the photon beam reflected by the first element.

20. A device for projecting comprising the system as claimed in claim 1.

21. A method for adapting a diameter of a photon beam comprising:
directing an incident photon beam onto a first element comprising a curved surface, the first element having a first focus and a second focus,
wherein the directing takes place in such a way that the received photon beam is focused into the first focus of the first element, with the directed photon beam being output as focused at the second focus, after reflection at the curved surface of the first element.

22. The method as claimed in claim 21, further comprising:
collimating the photon beam reflected at the first element to a first output diameter,
wherein the incident photon beam comprises a collimated photon beam with a first input diameter, and
wherein directing the incident photon beam further comprises:
varying a numerical aperture of the photon beam focused into the first focus and/or an angle of incidence at which the focused photon beam is focused into the first focus, so that the first output diameter varies.

23. A computer program comprising instructions which, when executed by a computer, causes the system of claim 1 to carry out a method for adapting a diameter of a photon beam comprising:
directing an incident photon beam onto a first element comprising a curved surface, the first element having a first focus and a second focus,
wherein the directing takes place in such a way that the received photon beam is focused into the first focus of the first element, with the directed photon beam being output as focused at the second focus, after reflection at the curved surface of the first element.
